(19) United States
(12) Patent Application Publication
(10) Pub. No.: US 2011/0082621 A1
(43) Pub. Date: Apr. 7, 2011

(54) METHOD AND SYSTEM FOR PREDICTING BATTERY LIFE BASED ON VEHICLE BATTERY, USAGE, AND ENVIRONMENTAL DATA

(76) Inventors: Eric Berkobin, Woodstock, GA (US); Bryant Elliott, Johns Creek, GA (US)

(21) Appl. No.: 12/897,690

(22) Filed: Oct. 4, 2010

Related U.S. Application Data
(60) Provisional application No. 61/248,386, filed on Oct. 2, 2009.

(51) Int. Cl. G06F 19/00

(52) U.S. Cl. 701/33

(57) ABSTRACT

A telematics device or a mobile wireless device, or a computer server remote from a vehicle, receives data related to the vehicle battery's open circuit and cranking voltages, temperature, and usage. The device compares the received data to predetermined corresponding criteria and also computes a battery health value based on the received data according to an algorithm. If the received data falls outside the corresponding criteria, the device can generate and send an alert to a user device. The battery health value can be sent to the user device to indicate remaining battery life, and to correlate temperature and vehicle usage with impact on battery life. The received data can also be used to generate a customized charging current profile that a charging device can use to regulate charging current from the vehicle's alternator to the battery. The vehicle can use an internal combustion engine, or be all-electric.

### CROSS REFERENCE TO RELATED APPLICATIONS

This application claims priority under 35 USC sec. 119 to U.S. Provisional Patent Application 61/248,386 having a filing date of Oct. 2, 2009, which this application incorporates herein by reference in its entirety.

### FIELD

The invention relates to determining and predicting performance and life of a battery in a vehicle.

### BACKGROUND

A lead-acid battery's surface charge phenomenon and the time the surface charge phenomenon takes to dissipate varies greatly from battery to battery (e.g., type, manufacturer, quality, age, etc.) and car to car (e.g., depending on ignition-off load). A measured value of a battery's surface charge conveys very little information other than that the battery may be new or high quality. Multiple surface charge measurements averaged over time to result in the Open Circuit Voltage (“OCV”), and/or, for example, discarding a first measurement of a set of measurements following a 30 minute period beginning at ignition-off OCV readings can provide better indications of battery health than just a single measurement of battery surface charge following ignition-off. One skilled in the art will appreciate that OCV may not be complete open circuit voltage, because some devices draw some small amounts of current even when the ignition key of the vehicle is in the off position. Some industry data suggests that a battery should rest for 3 hours before the combination of surface charge dissipation and the battery's temperature reaching ambient (e.g., after the vehicle's engine loses heat following operation) before measuring a battery's surface charge can indicate a reasonably accurate OCV. This stabilized OCV, along with a stabilized coolant temperature, suggests the best time to collect true at-rest ambient data is prior to a morning commute if the vehicle has rested overnight.

Starting-Lighting-Ignition (“SLI”) refers to a conventional car battery (also “shallow-cycle”) and distinguishes the same from a marine or house (“deep cycle”) application battery. The internal construction of the plates differs and gives up slow drain Amp-Hour capacity in exchange for higher cranking capacity. An SLI-type battery should remain fully charged for optimal life and doesn't like being discharged much or often.

A Flooded Lead Acid (“FLA”) battery is a conventional liquid-filled car battery in both maintenance-free and maintainable types. Some characteristics of a FLA include: (a) faster “self-discharge” rate . . . loss of charge during periods of nonuse; (b) shorter surface charge times than Absorptive Glass Mat (“AGM”); (c) less expensive than AGM; and (d) life expectancy varies based on metallurgical additives to the plates, and is reflected by retail price and warranty periods—typically between 24-months to 60-months.

As mentioned, another type of battery is AGM, characterized by electrolyte suspended in fiberglass mats between plates, slower sulfation, higher reserve capacity, and higher cold cranking amps (“CCA”). Some other characteristics of an AGM battery include: (a) slower “self-discharge” rate; (b) longer surface charge times than FLA; (c) typically more expensive than FLA; and (d) heavy, dense construction.

Another type of battery is Gel Cell. A gel cell uses an electrolyte mixed with silicate to stiffen it. This is not typically used for automotive SLI due to lower charge voltage and slower charge rate requirements, and lower cranking-amps. Currently, these tend to be suited for applications such as golf-carts and uninterruptible power supplies (“UPS”) applications, but could find use in hybrid or electric vehicles.

A typical automotive lead-acid battery uses six 2.1-volt cells in series to result in a 12.6 VDC nominal full charge. Any cell within a battery can short due to excess sulfation (sulfur can build-up on plates so much that they effectively ‘touch’ each other) dropping battery voltage by 2.1 VDC. Any cell can open if a contact between cells corrodes or excessive sulfation cracks the plates, especially at higher temperatures. The positive plates in a typical SLI car battery are actually not a solid plate but look more like a sponge or grid. This increases plate surface area, which increases cranking-amps by lowering the Internal Series Resistance (“ISR”). ISR is a key operating parameter of all batteries because it regulates how much current a battery can produce. Sulfation is the natural degradation of a lead-acid battery but is sped up by temperature extremes and infrequent or incomplete recharging. During sulfation, hard lead-sulfate crystals form on the positive plates of a battery. Charging typically cannot return the sulfur in the crystals to a dissolved state in a battery's electrolyte solution. In addition, frequent cranking of a vehicle can increase sulfation.

### BRIEF DESCRIPTION OF THE DRAWINGS

FIG. 1 Illustrates a schematic of an exemplary apparatus.

FIG. 2 Illustrates an exemplary system.

FIG. 3 Illustrates an exemplary operating environment for disclosed methods.

FIG. 4 Illustrates a flow diagram of a method for using received data to generate battery health alerts and to predict remaining battery life.

FIG. 5 Illustrates a plot of battery voltage versus for a period around a cranking event.

FIG. 6 illustrates a schematic diagram of a circuit for detecting battery cranking events.

### DESCRIPTION

The processing of the disclosed methods and systems can be performed by software components. The disclosed system and methods can be described in the general context of computer-executable instructions, such as program modules, being executed by one or more computers or other devices. Generally, program modules comprise computer code, routines, programs, objects, components, data structures, etc. that perform particular tasks or implement particular abstract data types. The disclosed methods can also be practiced in grid-based and distributed computing environments where tasks are performed by remote processing devices that are linked through a communications network. In a distributed computing environment, program modules can be located in both local and remote computer storage media including memory storage devices.

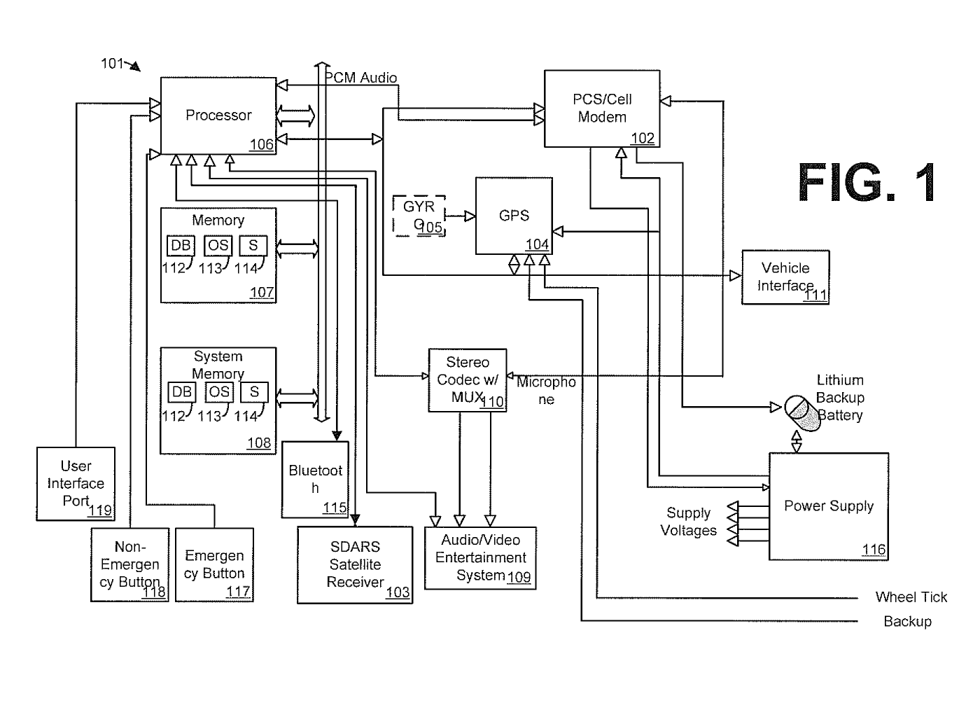

In one aspect, an apparatus comprising a telematics control unit (“TCU”) is installed in a vehicle. Such a vehicle may include, but is not limited to, personal and commercial automobiles, motorcycles, transport vehicles, watercraft, aircraft, and the like. For example, an entire fleet of a vehicle manufacturer's vehicles can be equipped with a TCU 101 shown in FIG. 1. TCU 101 can perform any of the methods disclosed herein in part and/or in their entireties.

A single box, or enclosure, may contain components of TCU 101, including a single core processing subsystem, or can comprise components distributed throughout a vehicle. Components of the apparatus can be separate subsystems of the vehicle; for example, a communications component such as a SDARS, or other satellite receiver, can be coupled with an entertainment system of the vehicle.

FIG. 1 illustrates an example of TCU 101, but does not suggest any limitation as to the scope of use or functionality of operating architecture. Neither should the TCU apparatus be necessarily interpreted as having any dependency or requirement relating to any one or combination of components illustrated in the exemplary apparatus. TCU apparatus 101 can comprise one or more communications components. Apparatus 101 illustrates communications components (modules) PCS/Cellular modem 102 and SDARS receiver 103. These components can be referred to as vehicle mounted transceivers when located in a vehicle. PCS/Cell Modem 102 can operate on any frequency available in the country of operation, including, but not limited to, the 850/1900 MHz cellular and PCS frequency allocations. The type of communication can include, but is not limited to GPRS, EDGE, UMTS, 1xRTT or EV-DO. The PCS/Cell modem 102 can be a Wi-Fi or mobile WIMAX implementation that can support operation on both licensed and unlicensed wireless frequencies. Apparatus 101 can comprise an SDARS receiver 103 or other satellite receiver. SDARS receiver 103 can utilize high powered satellites operating at, for example, 2.35 GHz to broadcast digital content to automobiles and some terrestrial receivers, generally demodulated for audio content, but can contain digital data streams.

PCS/Cell Modem 102 and SDARS receiver 103 can be used to update an onboard database 112 contained within, or coupled to, apparatus 101. TCU apparatus 101 can request updating, or updating can occur automatically. For example, database updates can be performed using FM subcarrier, cellular data download, other satellite technologies, Wi-Fi and the like. SDARS data downloads can provide the most flexibility and lowest cost by pulling digital data from an existing receiver that exists for entertainment purposes. An SDARS data stream is not a channelized implementation (like AM or FM radio) but a broadband implementation that provides a single data stream that is separated into useful and applicable components.

GPS receiver 104 can receive position information from a constellation of satellites operated by the U.S. Department of Defense. Alternatively GPS receiver 104 can be a GLONASS receiver operated by the Russian Federation Ministry of Defense, or any other positioning device capable of providing accurate location information (for example, LORAN, inertial navigation, and the like). GPS receiver 104 can contain additional logic, either software, hardware or both to receive the Wide Area Augmentation System (WAAS) signals, operated by the Federal Aviation Administration, to correct dithering errors and provide the most accurate location possible. Overall accuracy of the positioning equipment subsystem containing WAAS is generally in the two meter range. Optionally, apparatus 101 can comprise a MEMS gyro 105 for measuring angular rates and wheel tick inputs for determining the exact position based on dead-reckoning techniques. This functionality is useful for determining accurate locations in metropolitan urban canyons, heavily tree-lined streets, and tunnels.

In an aspect, the GPS receiver 104 can activate upon vehicle crank-up, or start of vehicle motion. GPS receiver 104 can go into idle on ignition off, or after ten minutes without vehicle motion. Time to first fix can be <45 s 90% of the time. For example, this can be achieved either through chipset selection or periodic wake-up of a processor in TCU 101.

One or more processors 106 can control the various components of the apparatus 101. Processor 106 can be coupled to removable/non-removable, volatile/non-volatile computer storage media. By way of example, FIG. 1 illustrates memory 107, coupled to the processor 106, which can provide non-volatile storage of computer code, computer readable instructions, data structures, program modules, and other data for the computer 101. For example and not meant to be limiting, memory 107 can be a hard disk, a removable magnetic disk, a removable optical disk, magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like. Data obtained and/or determined by processor 106 can be displayed to a vehicle occupant and/or transmitted to a remote processing center. This transmission can occur over a wired or a wireless network. For example, the transmission can utilize PCS/Cell Modem 102 to transmit the data over a cellular communication network. The data can be routed through the Internet where it can be accessed, displayed and manipulated.

Processing by the disclosed systems and methods can be performed under the control of software components. The disclosed system and method can be described in the general context of computer-executable instructions, such as program modules, being executed by one or more computers or other devices. Generally, program modules comprise computer code, routines, programs, objects, components, data structures, etc. that perform particular tasks; or implement, or manipulate, particular abstract data types. The disclosed methods can also be practiced in grid-based and distributed computing environments where tasks are performed by remote processing devices that are linked through a communications network. In a distributed computing environment, program modules can be located in both local and remote computer storage media including memory storage devices.

The methods and systems can employ Artificial Intelligence techniques such as machine learning and iterative learning. Examples of such techniques include, but are not limited to, expert systems, case based reasoning, Bayesian networks, behavior based AI, neural networks, fuzzy systems, evolutionary computation (e.g. genetic algorithms), swarm intelligence (e.g. ant algorithms), and hybrid intelligent systems (e.g. Expert inference rules generated through a neural network or production rules from statistical learning).

Any number of program modules can be stored in memory 107, including by way of example, an operating system 113 and reporting software 114. Each of the operating system 113 and reporting software 114 (or some combination thereof) can comprise elements of the programming and the reporting software 114. Data can also be stored on the memory 107 in database 112. Database 112 can be any of one or more databases known in the art. Examples of such databases comprise, DB2®, Microsoft® Access, Microsoft® SQL Server, Oracle®, mySQL, PostgreSQL, and the like, or any other way, or format, for storing data and information for later retrieval. Database 112 can be centralized, or distributed across multiple systems.

In some aspects, data can be stored and transmitted in loss-less compressed form and the data can be tamper-proof. Non-limiting examples of data that can be collected follow herein. After a connection is established the protocol being used can be stored. A timestamp can be recorded on ignition for one or more trips. Speed every second during the trip. Crash events can be stored (for example, as approximated via OBD II speed). By way of example, GPS related data that can be recorded during one or more trips can comprise one or more of, time, latitude, longitude, altitude, speed, heading, horizontal dilution of precision (HDOP), number of satellites locked, and the like. In one aspect, recorded data can be transmitted from the apparatus to a back-office for integrity verification and then via, for example, a cellular network. Once validated, data can be pushed to a company via established web-services & protocols.

By way of example, the operating system 113 can be a Linux (Unix-like) operating system. One feature of Linux is that it includes a set of “C” programming language functions referred to as “NDBM”. NDBM is an API for maintaining key/content pairs in a database which allows for quick access to relatively static information. NDBM functions use a simple hashing function to allow a programmer to store keys and data in data tables and rapidly retrieve them based upon the assigned key. A major consideration for an NDBM database is that it only stores simple data elements (bytes) and requires unique keys to address each entry in the database. NDBM functions provide a solution that is among the fastest and most scalable for small processors.

Such programs and components may reside at various times in different storage components of the apparatus 101, and may be executed by the processor 106 of apparatus 101. An implementation of reporting software 114 can be stored on or transmitted across some form of computer readable media. Computer readable media can be any available media that can be accessed by a computer. By way of example and not meant to be limiting, computer readable media can comprise “computer storage media” and “communications media.” “Computer storage media” comprise volatile and non-volatile, removable and non-removable media implemented in any method or technology for storage of information such as computer readable instructions, data structures, program modules, or other data. Exemplary computer storage media comprises, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

FIG. 1 illustrates system memory 108, coupled to the processor 106, which can comprise computer readable media in the form of volatile memory, such as random access memory (RAM, SDRAM, and the like), and/or non-volatile memory, such as read only memory (ROM). The system memory 108 typically contains data and/or program modules such as operating system 113 and reporting software 114 that are immediately accessible to and/or are presently operated on by the processor 106. The operating system 113 can comprise a specialized task dispatcher, slicing available bandwidth among the necessary tasks at hand, including communications management, position determination and management, entertainment radio management, SDARS data demodulation and assessment, power control, and vehicle communications.

The processor 106 can control additional components within the apparatus 101 to allow for ease of integration into vehicle systems. The processor 106 can control power to the components within the apparatus 101, for example, shutting off GPS receiver 104 and SDARS receiver 103 when the vehicle is inactive, and alternately shutting off the PCS/Cell Modem 102 to conserve the vehicle battery when the vehicle is stationary for long periods of inactivity. The processor 106 can also control an audio/video entertainment subsystem 109 and comprise a stereo codec and multiplexer 110 for providing entertainment audio and video to the vehicle occupants, for providing wireless communications audio (PCS/Cell phone audio), speech recognition from the driver compartment for manipulating the SDARS receiver 103 and PCS/Cell Modem 102 phone dialing, and text to speech and pre-recorded audio for vehicle status annunciation.

TCU apparatus 101 can interface and monitor various vehicle systems and sensors to determine vehicle conditions. Apparatus 101 can interface with a vehicle through a vehicle interface 111. The vehicle interface 111 can include, but is not limited to, OBD (On Board Diagnostics) port, OBD-II port, CAN (Controller Area Network) port, and the like. TCU 101 may also be integrated into a vehicle and be coupled, either by conductors, fiber cable, or wirelessly, to a vehicle's communication and computer system. A cable can be used to connect the vehicle interface 111 to a vehicle. Any type of cable capable of connecting to a vehicle diagnostics port can be used. In one aspect, an OBD II connector cable can be used that follows the J1962 trapezoidal connector specification, the J1939 or J1708 round connector specifications, and the like. A communication protocol such as, J1850 PWM, J1850 VPW, IS09141-2, IS014230-4, IS015765-4, and the like can be used to collect data through the vehicle interface 111. The vehicle interface 111, allows the apparatus 101 to receive data indicative of vehicle performance, such as vehicle trouble codes, operating temperatures, operating pressures, speed, fuel air mixtures, oil quality, oil and coolant temperatures, wiper and light usage, mileage, break pad conditions, and any other data obtained from any vehicle system, subsystem, or sensor, coupled with the TCU 101, such as over bus using CAN protocol, an ISO protocol, a keyword 2000 protocol, or a similar protocol for interfacing various sensors, modules, and computers in a vehicle with each other. Additionally, CAN interfacing can eliminate individual dedicated inputs to determine, for example, brake usage, backup status, and it can allow reading of onboard sensors in certain vehicle stability control modules providing gyro outputs, steering wheel position, accelerometer forces and the like for determining driving characteristics. TCU apparatus 101 can interface directly with a vehicle subsystem or a sensor, such as, for example, an accelerometer, gyroscope, airbag deployment computer, and the like. Data obtained from, and processed data derived from, the various vehicle systems and sensors can be transmitted to a central monitoring station via the PCS/Cell Modem 102 over a communication network.

Communication with a vehicle driver can be through an infotainment (radio) head unit (not shown), or other display device (also not shown). More than one display device can be used. Examples of display devices include, but are not limited to, a monitor, an LCD (Liquid Crystal Display), a projector, and the like. Audio/video entertainment subsystem 109 can comprise a radio receiver, FM, AM, Satellite, Digital and the like. Audio/video entertainment subsystem 109 can comprise one or more media players. An example of a media player includes, but is not limited to, audio cassettes, compact discs, DVD's, Blu-ray, HD-DVDs, Mini-Discs, flash memory, portable audio players, hard disks, game systems, and the like. Audio/video entertainment subsystem 109 can comprise a user interface for controlling various functions. The user interface can comprise buttons, dials, and/or switches. In certain embodiments, the user interface can comprise a display screen. The display screen can be a touch screen. The display screen can be used to provide information about the particular entertainment being delivered to an occupant, including, but not limited to Radio Data System (RDS) information, ID3 tag information, video, and various control functionality (such as next, previous, pause, etc. . . . ), websites, and the like. Audio/video entertainment subsystem 109 can utilize wired or wireless techniques to communicate to various consumer electronics including, but not limited to, cellular phones, laptops, PDAs, portable audio players, and the like. Audio/video entertainment subsystem 109 can be controlled remotely through, for example, a wireless remote control, voice commands, and the like.

The methods, systems, and apparatuses disclosed herein can utilize power management techniques to ensuring that a consumer's, or motorist's, car battery is not impaired under normal operating conditions. This can include battery backup support when the vehicle is turned off in order to support various wake-up and keep-alive tasks. All data collected subsequent to the last acknowledged download can be maintained in non-volatile memory until the apparatus is reconnected to an external power source. At that point, the apparatus can self re-initialize and resume normal operation. Specific battery chemistry can optimize life/charge cycles. The battery can be rechargeable. The battery can be user replaceable or non-user replaceable.

TCU apparatus 101 can receive power from power supply 114. The power supply can have many unique features necessary for correct operation within the automotive environment. One mode is to supple a small amount of power (typically less than 100 microamps) to at least one master controller that can control all the other power buses inside of the TCU 101. In an exemplary system, a low power low dropout linear regulator supplies this power to PCS/Cellular modem 102. This provides the static power to maintain internal functions so that it can await external user push-button inputs or await CAN activity via vehicle interface 111. Upon receipt of an external stimulus via either a manual push button or CAN activity, the processor contained within the PCS/Cellular modem 102 can control the power supply 114 to activate other functions within TCU 101, such as GPS 104/GYRO 105, Processor 106/memory 107 and 108, SDARS receiver 103, audio/video entertainment system 109, audio codec mux 110, and any other peripheral within the TCU that does not require standby power.

Processors in a TCU can have a plurality of power supply states. One state can be a state of full power and operation used when the vehicle is operating. Another state can be full power delivery from battery backup. Turning off the GPS and other non-communication related subsystem while operating on the back-up batteries can reduce backup power usage. Another state can be when the vehicle associated with TCU 101 has been shut off recently, perhaps within the last 30 days, and the TCU maintains communication over a two-way wireless network for various auxiliary services like remote door unlocking and location determination messages. After a recent shut down period, it is desirable to conserve charge in the vehicle's battery by turning off almost all power-using portions of TCU 101, except portions used to maintain system time of day clocks, and other functions waiting to be awakened on CAN activity. Additional power states are contemplated, such as a low power wakeup to check for network messages. Normal operation can comprise, for example, the PCS/Cellular modem 102 waiting for an emergency pushbutton key-press from a user interface device, or for CAN activity. Once either is detected, the PCS/Cellular modem 102 can awaken and enable power supply 114. Similar operation can occur for a shutdown process wherein a first level shutdown process turns off everything except the PCS/Cellular modem 102, for example. The PCS/Cellular modem 102 can maintain wireless network contact during this state of operation. TCU 101 can operate normally in this state when the vehicle is turned off. If the vehicle is off for an extended period of time, perhaps over a vacation etc., the PCS/Cellular modem 102 can be dropped to a very low power state where it no longer maintains contact with the wireless network.

Additionally, in FIG. 1, subsystems can include a BlueTooth transceiver 115 that can facilitate interfacing with devices such as phones, headsets, music players, and telematics user interfaces. The apparatus can comprise one or more user inputs, such as emergency button 117 and non-emergency button 118. Emergency button 117 can be coupled to processor 106. The emergency button 117 can be located in a vehicle cockpit and activated an occupant of the vehicle. Activation of the emergency button 117 can cause processor 106 to initiate a voice and data connection from the vehicle to a central monitoring station, also referred to as a remote call center. Data such as GPS location and occupant personal information can be transmitted to the call center. The voice connection permits two way voice communication between a vehicle occupant and a call center operator. The call center operator can have local emergency responders dispatched to the vehicle based on the data received. In another embodiment, the connections are made from the vehicle to an emergency responder center.

One or more non-emergency buttons 118 can be coupled to processor 106. Non-emergency buttons 118 can be located in a vehicle cockpit and activated by an occupant of the vehicle. Activation of the one or more non-emergency buttons 118 can cause processor 106 to initiate a voice and data connection from the vehicle to a remote call center. Data such as GPS location and occupant personal information can be transmitted to the call center; a TOC can use this information to retrieve vehicle and motorist information, such as drug allergies or other medical issues particular to a given motorist. The voice connection permits two way voice communications between a vehicle occupant and a call center operator. The call center operator, such as a operator working for a telematics services provider, or working for a roadside assistance operator, can provide location based services to the vehicle occupant based on the data received and the vehicle occupant's desires, as well as the needs of a service provider. For example, a button can provide a vehicle occupant with a link to roadside assistance services such as towing, spare tire changing, refueling, and the like, either directly or through an intermediary call center, such as a telematics service provider or a membership-based roadside assistance provider. In another embodiment, a button can provide a vehicle occupant with concierge-type services, such as local restaurants, their locations, and contact information; local service providers their locations, and contact information; travel related information such as flight and train schedules; and the like.

For any voice communication made through TCU 101, text-to-speech algorithms can be used so as to convey predetermined messages in addition to or in place of a vehicle occupant speaking. This allows for communication when the vehicle occupant is unable or unwilling to communicate vocally.

In an aspect, apparatus 101 can be coupled to a telematics user interface located remote from the apparatus. For example, the telematics user interface can be located in the cockpit of a vehicle in view of vehicle occupants while the apparatus 101 is located under the dashboard, behind a kick panel, in the engine compartment, in the trunk, or generally out of sight of vehicle occupants.

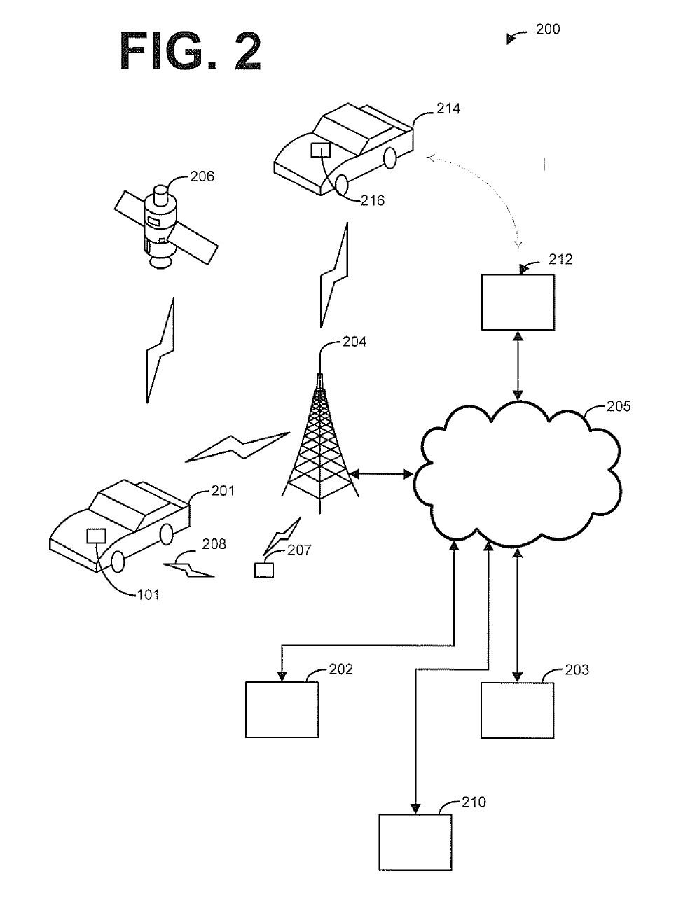

FIG. 2 is a block diagram illustrating an exemplary telematics system 200 showing network connectivity between various components. System 200 can comprise a TCU 101 located in a motor vehicle 201 and a mobile communication device 207. Mobile communication device can be a pager, a device having cellular phone circuitry, a PDA, a laptop, and the like. System 200 can comprise a central monitoring station 202. The central monitoring station 202 can serve as a market specific data gatekeeper. That is, users 203 can pull information from specific, multiple or all markets at any given time for immediate analysis. The distributed computing model has no single point of complete system failure, thus minimizing downtime of system 200. In an embodiment, central monitoring station 202 can communicate through an existing communications network (e.g., wireless towers 204 and communications network 205) with the TCU 101 and the mobile communication device 207. In another embodiment, TCU 101 can communicate directly with the mobile communication device 207. System 200 can comprise at least one satellite 206 from which GPS data are determined. These signals can be received by a GPS receiver in the vehicle 201. Station 202 can also include servers for providing telematics services, and for storing telematics-related customer and vehicle information.

System 200 can comprise a plurality of users 203 (governments, corporations, individuals, and the like) which can access the system using a computer, or other computing device, running a commercially available Web browser or client software. For simplicity, FIG. 2 shows only one user 203. Users 203 can connect to the telematics navigation system 200 via the communications network 205. In an embodiment, communications network 205 can comprise the Internet.

Telematics system 200 can comprise a central computer, or monitoring station, 202 which can comprise one or more central monitoring station servers. In some aspects, one or more central monitoring station servers can serve as the “back-bone” (i.e., system processing) of system 200. One skilled in the art will appreciate that telematics system 200 can utilize servers (and databases) physically located on one or more computers and at one or more locations, such as 210 and 212. Central monitoring station server can comprise software code logic that is responsible for handling tasks such as route determination, traffic analysis, map data storage, location data storage, POI data storage, data interpretations, statistics processing, data preparation and compression for output to TCU 101, and interactive route planning, location and POI searching, and the like, for output to users 203. In an embodiment, user 203 can host a server (also referred to as a remote host) that can perform similar functions as a central monitoring station server. In an embodiment of telematics system 200, central monitoring station servers and/or remote host servers, can have access to a repository database which can be a central store for a portion of or all information within telematics system 200 (e.g., executable code, map, location, POI information, subscriber information such as login names, passwords, etc., and vehicle and demographics related data).

In an aspect, central monitoring station 202 can provide updates to TCU 101 including, but not limited to, map updates, POI updates, routing software updates, and the like.

Central monitoring station servers and/or a remote host server can also provide a “front-end” for telematics system 200. That is, a central monitoring station server can comprise a web server for providing a web site which sends out web pages in response to requests from remote browsers (i.e., users 203, or customers of users 203). More specifically, a central monitoring station server and/or a remote host server can provide a graphical user interface (GUI) “front-end” to users 203 of the telematics navigation system 200 in the form of Web pages. These Web pages, when sent to the user PC, mobile wireless device (or the like), can result in GUI screens being displayed. Alternatively, applications running on user devices 207, which may be mobile wireless devices that interface via short range wireless communication links 208 to TCU 101, can transmit and receive vehicle parameter information, and process and display same either received from TCU 101 or received from a remote server computer. Put another way, a mobile wireless device can perform some functions that a TCU can perform, or can function as a wireless transceiver for communicating data, received from TCU 101, over links 207, and can also receive processed information from a server that it previously wirelessly transmitted to the server.

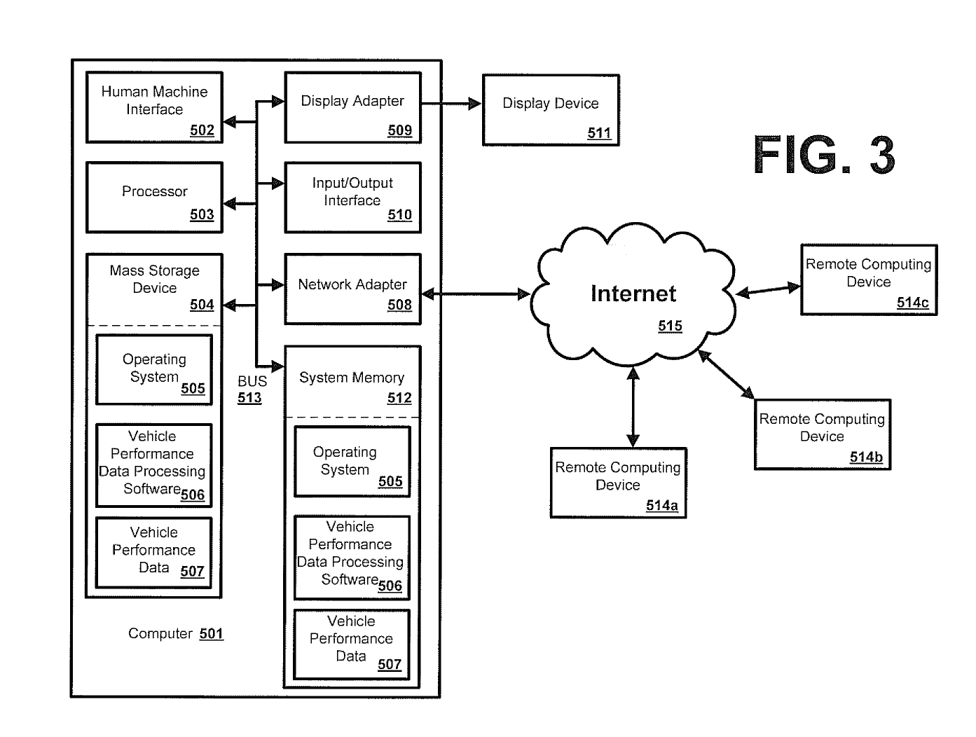

FIG. 3 is a block diagram illustrating an exemplary operating environment for performing the disclosed methods, for example, a server, or other computing device, at a remote host or a central monitoring station. This exemplary operating environment is only an example of an operating environment and is not intended to suggest any limitation as to the scope of use or functionality of operating environment architecture. Neither should the operating environment be interpreted as having any dependency or requirement relating to any one or combination of components illustrated in the exemplary operating environment.

The methods and systems can be operational with numerous other general purpose or special purpose computing system environments or configurations. Examples of well known computing systems, environments, and/or configurations that can be suitable for use with the system and method comprise, but are not limited to, personal computers, server computers, laptop devices, and multiprocessor systems. Additional examples comprise set top boxes, programmable consumer electronics, network PCs, minicomputers, mainframe computers, distributed computing environments that comprise any of the above systems or devices, and the like.

In another aspect, the methods and systems can be described in the general context of computer instructions, such as program modules, being executed by a computer. Generally, program modules comprise routines, programs, objects, components, data structures, etc. that perform particular tasks or implement particular abstract data types. The methods and systems can also be practiced in distributed computing environments where tasks are performed by remote processing devices that are linked through a communications network. In a distributed computing environment, program modules can be located in both local and remote computer storage media including memory storage devices.

Further, one skilled in the art will appreciate that the systems and methods disclosed herein can be implemented via a general-purpose computing device in the form of a computer device, or computer 501. The components of computer 501 can comprise, but are not limited to, one or more processors or processing units 503, a system memory 512, and a system bus 513 that couples various system components including the processor 503 to the system memory 512.

The system bus 513 represents one or more of several possible types of bus structures, including a memory bus or memory controller, a peripheral bus, an accelerated graphics port, and a processor or local bus using any of a variety of bus architectures. By way of example, such architectures can comprise an Industry Standard Architecture (ISA) bus, a Micro Channel Architecture (MCA) bus, an Enhanced ISA (EISA) bus, a Video Electronics Standards Association (VESA) local bus, an Accelerated Graphics Port (AGP) bus, and a Peripheral Component Interconnects (PCI) bus, PCI-Express bus, Universal Serial Bus (USB), and the like. The bus 513, and all buses specified in this description can also be implemented over a wired or wireless network connection and each of the subsystems, including the processor 503, a mass storage device 504, an operating system 505, navigation software 506, navigation data 507, a network adapter (or communications interface) 508, system memory 512, an Input/Output Interface 510, a display adapter 509, a display device 511, and a human machine interface 502, can be contained within one or more remote computing devices 514a,b,c at physically separate locations, connected through buses of this form, in effect implementing a fully distributed system. In one aspect, a remote computing device can be a TCU.

The computer 501 typically comprises a variety of computer readable media. Exemplary readable media can be any available media that is accessible by the computer 501 and comprises, for example and not meant to be limiting, both volatile and non-volatile media, removable and non-removable media. The system memory 512 comprises computer readable media in the form of volatile memory, such as random access memory (RAM), and/or non-volatile memory, such as read only memory (ROM). The system memory 512 typically contains data such as navigation data 507 and/or program modules such as operating system 505 and navigation software 506 that are immediately accessible to and/or are presently operated on by the processing unit 503. Navigation data 507 can comprise any data generated by, generated for, received from, or sent to TCU 101.

In another aspect, the computer 501 can also comprise other removable/non-removable, volatile/non-volatile computer storage media. By way of example, FIG. 3 illustrates a mass storage device 504 which can provide non-volatile storage of computer code, computer readable instructions, data structures, program modules, and other data for the computer 501. For example and not meant to be limiting, a mass storage device 504 can be a hard disk, a removable magnetic disk, a removable optical disk, magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like.

Optionally, any number of program modules can be stored on the mass storage device 504, including by way of example, an operating system 505 and navigation software 506. Each of the operating system 505 and navigation software 506 (or some combination thereof) can comprise elements of the programming and the navigation software 506. Navigation data 507 can also be stored on the mass storage device 504. Navigation data 507 can be stored in any of one or more databases known in the art. Examples of such databases comprise, DB2®, Microsoft® Access, Microsoft® SQL Server, Oracle®, mySQL, PostgreSQL, and the like. The databases can be centralized or distributed across multiple systems.

In another aspect, the user can enter commands and information into the computer 501 via an input device (not shown). Examples of such input devices comprise, but are not limited to, a keyboard, pointing device (e.g., a “mouse”), a microphone, a joystick, a scanner, tactile input devices such as gloves, and other body coverings, a haptic interface, and the like These and other input devices can be connected to the processing unit 503 via a human machine interface 502 that is coupled to the system bus 513, but can be connected by other interface and bus structures, such as a parallel port, game port, an IEEE 1394 Port (also known as a Firewire port), a serial port, or a universal serial bus (USB).

In yet another aspect, a display device 511 can also be connected to the system bus 513 via an interface, such as a display adapter 509. It is contemplated that the computer 501 can have more than one display adapter 509 and the computer 501 can have more than one display device 511. For example, a display device can be a monitor, an LCD (Liquid Crystal Display), or a projector. In addition to the display device 511, other output peripheral devices can comprise components such as speakers (not shown) and a printer (not shown) which can be connected to the computer 501 via Input/Output Interface 510. Any step and/or result of the methods can be output in any form to an output device. Such output can be any form of visual representation, including, but not limited to, textual, graphical, animation, audio, tactile, and the like.

The computer 501 can operate in a networked environment using logical connections to one or more remote computing devices 514a,b,c. By way of example, a remote computing device can be a personal computer, portable computer, a server, a router, a network computer, a TCU, a PDA, a cellular phone, a “smart” phone, a wireless communications enabled key fob, a peer device or other common network node, and so on. Logical connections between the computer 501 and a remote computing device 514a, b, c can be made via a local area network (LAN) and a general wide area network (WAN). Such network connections can be through a network adapter 508. A network adapter 508 can be implemented in both wired and wireless environments. Such networking environments are conventional and commonplace in offices, enterprise-wide computer networks, intranets, and the Internet 515. In one aspect, the remote computing device 514a,b,c can be one or more TCUs 101.

For purposes of illustration, application programs and other executable program components such as the operating system 505 are illustrated herein as discrete blocks, although it is recognized that such programs and components reside at various times in different storage components of the computing device 501, and are executed by the data processor(s) of the computer. An implementation of navigation software 506 can be stored on or transmitted across some form of computer readable media. Computer readable media can be any available media that can be accessed by a computer. By way of example and not meant to be limiting, computer readable media can comprise “computer storage media” and “communications media.” “Computer storage media” comprise volatile and non-volatile, removable and non-removable media implemented in any method or technology for storage of information such as computer readable instructions, data structures, program modules, or other data. Exemplary computer storage media comprises, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

The processing of the disclosed methods and systems can be performed by software components. The disclosed system and method can be described in the general context of computer-executable instructions, such as program modules, being executed by one or more computers or other devices. Generally, program modules comprise computer code, routines, programs, objects, components, data structures, etc. that perform particular tasks or implement particular abstract data types. The disclosed methods can also be practiced in grid-based and distributed computing environments where tasks are performed by remote processing devices that are linked through a communications network, including long range and short range wireless links. In a distributed computing environment, program modules can be located in both local and remote computer storage media including memory storage devices.

As used herein in the method descriptions that follow, in certain embodiments, “in-vehicle system” can comprise a system that is installed in a vehicle, either at a factory, dealer, or by the user. In other embodiments, “in-vehicle system” can comprise components and systems that can be used outside of a vehicle. In various embodiments, the in-vehicle system can comprise a telematics device, a navigation system, an infotainment system, combinations thereof, and the like. The “remote host” can be a central monitoring station, or other host that maintains computing and communications systems configured for carrying out the methods.

A TCU, either installed in a vehicle by a manufacturer, removably fixed to a vehicle, or merely substantially immovably placed into a vehicle can collect data from the vehicle and transmit it to a central computer for processing, evaluation, and analysis. TCU 101 may transmit the vehicle data over wireless links 107, or over links 208 to mobile wireless device 207, which may transmit the data to a remote computer via a long range wireless link. A temperature sensor inside TCU 101 can function as a limited “weather station.” Although TCU 101 may not be located close to a vehicle's battery (especially for batteries mounted under a hood or in an engine compartment, mounting or placing under a dashboard, for example, improves temperature monitoring vis-á-vis dash mounting, which exposes the TCU to direct sunlight. TCU 101 can retrieve and transmit Engine Coolant Temperature (“ECT”) via an OBD, OBD2, or similar diagnostic port on vehicles that support the ECT parameter while the engine is running. A program running on TCU 101 also can determine when the vehicle's ignition is on and when it is off.

An ECT reading more accurately indicates ambient outside temperature of a vehicle if the vehicle has been sitting for a long time and the engine coolant temperature has stabilized. TCU 101 can also retrieve Intake Air Temperature (“IAT”) via the vehicle's diagnostic port—IAT can provide a somewhat accurate indication of ambient temperature adjusted down for running engine heat. Thus, TCU 101 can retrieve, process, and wirelessly transmit ECT, IAT, and ambient temperature surrounding the TCU itself for use in estimating and predicting a vehicle's battery temperature.

For example, a program running on processor in TCU 101 can receive battery voltage data during a predetermined cranking period (e.g., during a time period that triggers when OCV drops below a predetermined trigger threshold and counts down the predetermined period) and determine and detect excessive cranking if battery voltage stays below a predetermined cranking threshold for the predetermined cranking period. Or, TCU 101 can detect, for example, that OCV<11.4-11.8 and determine that the battery may not turn the engine over.

In another aspect, TCU 101, or a program running at computer, or mobile wireless device, remote from the TCU that processes data that the TCU wirelessly transmits, can compare total cranking time and compare to a criterion as a factor in predicting remaining life of the battery. TCU 101, or the remote computer, or other device, can compile the amount of time that a battery voltage is below a cranking threshold following a corresponding cranking event trigger, and use the total cranking time as a factor in predicting how much cranking activity the battery has provided current for. The algorithm may include an assumption that the life of a battery is inversely related to the time it has spent providing current to crank a vehicle, all other factors being equal.

Another factor that TCU 101 can detect, and either analyze or wirelessly transmit, is low OCV. For example, if steady state OCV˜11.8, the algorithm can assume that a, driver is sitting in a vehicle with the engine off, but with lights and/or accessories on.

Another factor TCU 101 can detect, and either analyze or wirelessly transmit is whether the plates of a cell have shorted together. When plates of a cell short, overall battery voltage typically drops 2.1V, depending on the type of battery. Two shorted cells would result in a total drop of 4.2V and three shorted cells would result in a total drop of 6.3V, and so on. Naturally, a shorted cell probably cannot be repaired, and an alert or report to a user that a cell has shorted can include a warning that the battery condition is critical and must be replaced. However, if sulfation deposits have just barely contacted from one plate to the other, some charging algorithms may be able to break the sulfation deposits enough so that the plates are separated, perhaps rendering the battery useful again for at least one or two more cranking events until a replacement has been procured and installed in the vehicle.

Another factor TCU 101 can detect, and either analyze or wirelessly transmit is whether the battery voltage drops to a minimum operating voltage of the TCU itself. This could be set at a first operating voltage or a different, or second, operating voltage if the TCU has a back up battery (“BUB”).

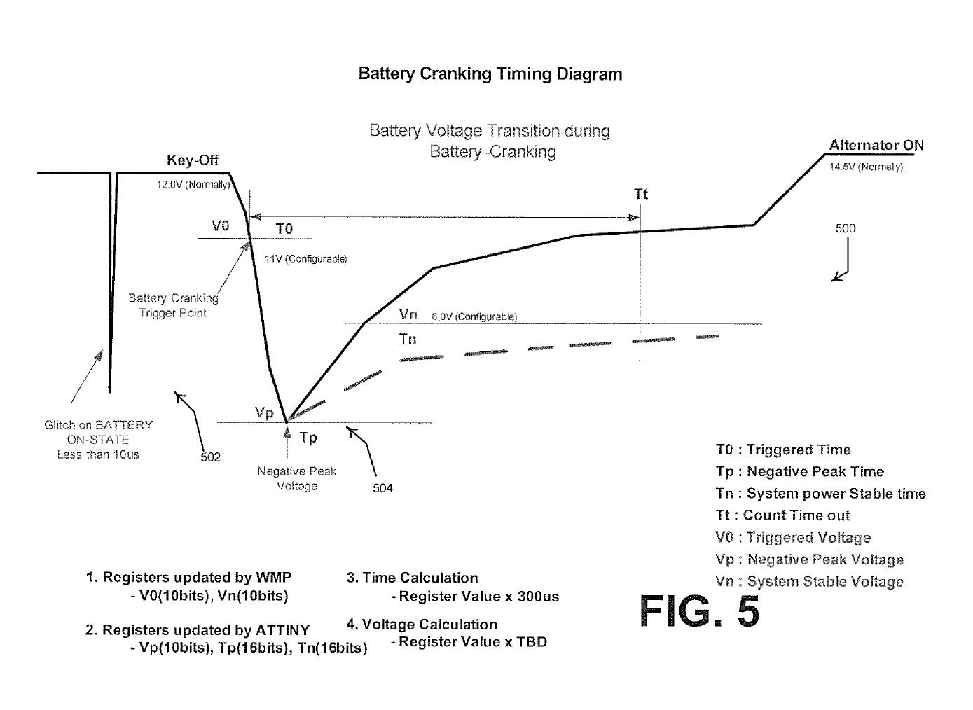

The sulfation process can slowly cause battery degradation over time. Symptoms of sulfation degradation include steady state OCV decreases over time, increasingly rapid battery discharge to OCV after ignition off, and lower crank tip voltage (the low voltage point following crank trigger shown as the lowest voltage point in FIG. 5). A combination of sulfation indications, or factors, combined with measured environmental factor values (e.g. various temperature values), and driving characteristic factor values (e.g., ratio of short trips versus long trips, accessory load while driving) can “predict” a shorted cell condition.

Crystals resulting from sulfation often result in a shorted cell, or reduced ability to retain a charge and deliver current to a load (engine starter). Thus, an evaluation of OCV, cranking voltage versus time, and voltage-performance trend values may be used to predict an upcoming short circuited cell condition or reduced capacity for a cell plate to store charge. As described above, TCU 101, or a computer server that receives data wirelessly transmitted from the TCU, can generate and send an alert in an electronic message, such as in an e-mail message and/or a text message alerting of the degraded battery condition. The alert message may indicate that a battery voltage parameter measurement, an environmental parameter measurement, and/or a driver characteristic parameter value

Another factor, or parameter, a TCU can measure or determine, is that electrolyte degradation has occurred. Electrolyte degradation refers to a condition in a maintainable FLA battery (a battery that one can easily add de-ionized water to each of the 6 cells) where the fluid level(s) are low (plates exposed to air). A battery with a low electrolyte level may discharge more quickly and recharge more quickly than an otherwise similar battery with a proper electrolyte fluid level. Such a condition may exhibit characteristics similar to those of sulfation, and TCU 101, or a computer server that receives data wirelessly transmitted from the TCU, can generate and send an alert in an electronic message, such as in an e-mail message and/or a text message alerting of the degraded battery condition. The message may contain an instruction to check the battery's fluid level.

Another condition that can occur is an open cell, which would result in a total loss of output from a battery. This would be detected if TCU 101 does not have a backup battery, and does not wirelessly transmit an signal when a central computer expects it to.

In addition to monitoring, measuring, and analyzing battery voltage data to assess and predict battery health and remaining useful life, other condition and driver behavior data can enhance the accuracy of the assessment and prediction algorithm, some of which are listed and described now.

Extreme operating temperatures, both hot and cold, affect almost all battery types. High temperature increases the rate of sulfation, especially in batteries not kept fully charged. When exposed to cold temperatures, a typical vehicle battery's charge capacity typically falls 1%/degree when the battery is exposed to temperatures below 20° C. (electrolyte mobility is inhibited and becomes inefficient but will recover as temperature increases). Thus, providing information regarding cranking amps as cold cranking amps (“CCA”) gives a useful indication for determining how a given battery may perform in a degraded condition, even if it ultimately performs better when the temperature surrounding it warms up.

In addition to reducing sulfation, cold temperature battery charge level can indicate battery longevity in another way. Typically, the greater the battery charge the higher the concentration of sulfur dissolved in the electrolyte solution and thus the lower the electrolyte freezing temperature. The less charged a battery is the higher the temperature at which its electrolyte will freeze. Accordingly, monitoring, determining, and measuring battery charge and sulfation levels using techniques described above (i.e., measuring OCV and time to return to nominal OCV voltage after a cranking event or after an alternator stops charging the battery).

Another parameter, or factor, that can indicate that a battery may have a shortened life is excessive engine cranking (i.e., after cranking, insufficient time to recharge from engine alternator). Excessive cranking can be determined by measuring parameters and factors that indicate conditions that correspond to excessive cranking. For example, TCU 101, or information that is wirelessly transmits, can determine that a vehicle has taken many (more than a predetermined number) short trips can. During a short trip, for example less than five miles, a battery may not fully recharge following the charge depletion that occurred during cranking before the trip. Such short trips where a battery does not fully recharge can result in sulfation.

Another parameter that can indicate that a battery may have a shortened life is infrequent driving. A battery tends to ‘self-discharge’ as it sits idle and is not recharged often, typically leading to sulfation. The battery industry commonly understands that an OCV of about 10.5V typically corresponds to a ruined battery, because sulfation has probably occurred to the point of the battery being unusable inasmuch as it probably cannot crank a vehicle engine or hold a charge, among other inabilities.

To reduce and counteract the effects of sulfation, some battery charger devices have a “desulfate” mode that typically bursts high current to de-crystallize the crystalline lead-sulfate from the plates. But, results from these devices are mixed. TCU 101 can function cooperatively with a power regulating device to regulate and/or modify the charging current produced by a vehicle's alternator. For example, a power regulating device may comprise a power transistor, SCR, triac, or similar device that can react to a control signal to control the charging current presented to a battery. The power regulating device may be installed electrically between the alternator and the battery—most likely in series with a charging wire coupled to the alternator between the alternator and the battery anode (the terminal which receives current from an external generator during recharging).

Evaluation of data corresponding to one, some, or all, of the parameters. factors, and characteristics described above can provide a better assessment of the health and remaining life of a battery than just the amount of time that has passed since it was purchased or placed in service. As an example, for a driver with a short commute to work in a warm climate, such as in Florida, having typically high ambient temperatures, a battery failure during the summer would typically be caused by the extreme temperature and short trip characteristics. As discussed above, both tend to exacerbate sulfation, which tends to facilitate the cracking of a positive plate and thus an instant & total loss of battery voltage. By monitoring battery, environmental, and driving behavior data, evaluating it, either with a computer program running on TCU 101, or at a computer or mobile wireless device remote from the TCU that has received the data that the TCU wirelessly transmitted, alerts generated as a result of the evaluation can notify and inform a driver, or owner, that a battery may need replacing soon, even though the driver, or owner, may not have notice degraded battery performance.

An algorithm running on a TCU either installed by a vehicle's manufacturer and coupled to a communications bus, such as a controller area network (“CAN”) bus, or an aftermarket device coupled to the vehicle via a diagnostics port, such as, for example, and OBD port, can perform an algorithm that stores measured data corresponding to predetermined parameters to a memory. The algorithm may also run on a mobile wireless device that communicates with TCU 101. For example, TCU 101 may store a number of minutes a vehicle starter operates (based on monitoring battery voltage and detecting a trigger and detecting subsequent voltage rise above a threshold) and the current drawn from the battery during the cranking activity (integrating V/R where R is a predetermined resistance value representing the battery's internal resistance and the resistance between the battery terminal and the measuring point) during a period, such as a day, a week, or a month. The TCU processor could then (after the end of the period) retrieve the total cranking time and current drawn and compare the stored values to predetermined criteria. If the vehicle starter operated more minutes than the predetermined criterion for cranking time during a corresponding period, or drew more current that the predetermined criteria, or lowered the battery voltage below a predetermined criteria the TCU could initiate the sending of an alert to a user that the battery has likely degraded more than an average amount during the period. Similarly, if the OCV drops after recharging more quickly, or to a lower value, than a predetermine criteria, the TCU can initiate the sending of an e-mail, SMS, voice, page, or other electronic message that the TCU has determined that the battery in the vehicle is nearing the end of its useful life.

Alternatively, the TCU can monitor and process (or monitor and forward) data corresponding certain parameters, such as the OCV after charging, the amount of cranking during a period, the battery voltage drop of cranking during that period, the average ambient temperature during a predetermined period, average length of trips, frequency of trips, etc. and forward data corresponding to the monitored parameters to a telematics operations center (“TOC”) at a central location, or to some other computer remote with respect to the vehicle and TCU. The central location's TOC could then perform the analysis of comparing the monitored data to predetermined criteria and then initiate the sending of alerts to users. Accordingly, either a TCU, a mobile wireless device, or a TOC can receive and process battery parameter data, battery environmental data, and vehicle usage information and data according to predetermined criteria and algorithms to predict remaining life of the battery in a vehicle, and initiate the generating and sending of alerts to an owner, user, or other party interested in knowing the remaining useful life of the battery.

In addition to using data from monitored vehicle usage parameters, the TOC, mobile wireless remote device, or TCU can acquire OCV at a predetermined time, such as early in the morning, or at other times after a predetermined period of non-use, and compare the OCV to thresholds, such as given below in the state of charge chart. The TCU or TOC can generate an alert based on what range the current OCV falls in. Also, the factors discussed above can be assigned a weighting value and if battery data, environmental data, and/or driver behavior data falls outside of, or fails to meet, predetermined criteria for a corresponding parameter, the weighting factor can be used either alone, or multiplied by the corresponding parameter data, and combined with other similarly processed data, to determine a battery health, or battery remaining life value. For example, a new battery placed into service for use in a vehicle operated in Alaska for primarily short trips would typically achieve a value indicating a shortened life more quickly than a similar battery operating in California for mostly long trips. The temperature measurements either received through the OBD port, or from a temperature sensor that measures ambient air, would report temperature, the duration of time the engine is on could be determined from the amount of time battery voltage is at or near alternator voltage, and the batter characteristic data, such as time to return to a nominal OCV following engine off, could be combined according to the weighting factors to determine the remaining battery life value.

TABLE 1

| State of Charge | 12 Volt battery | Volts per Cell |
|---|---|---|
| 100% | 12.7 | 2.12 |
| 90% | 12.5 | 2.08 |
| 80% | 12.42 | 2.07 |
| 70% | 12.32 | 2.05 |
| 60% | 12.20 | 2.03 |
| 50% | 12.06 | 2.01 |
| 40% | 11.9 | 1.98 |
| 30% | 11.75 | 1.96 |
| 20% | 11.58 | 1.93 |
| 10% | 11.31 | 1.89 |
| 0 | 10.5 | 1.75 |

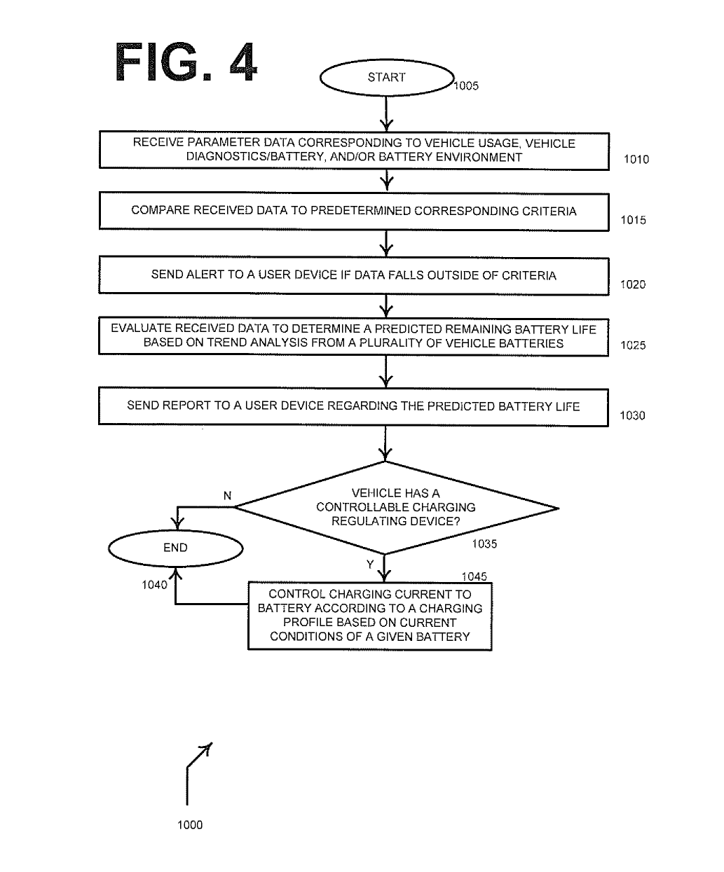

Turning now to FIG. 4, the figure illustrates a flow diagram of a method 1000 for monitoring data related to battery health and generating alerts and reports for sending to a user device. Method 1000 may be included in software instruction in a program running on a processor of TCU installed in a vehicle during vehicle manufacture, or in an aftermarket telematics control unit that receives data from the vehicle through a diagnostics port of the vehicle. The TCU may also have its own sensors, such as, for example, accelerometer and temperature sensor. In addition, a program that includes the steps of method 1000 can run on a wireless mobile device, such as, for example, a smartphone, a cell phone, a computer, and the like, wherein the wireless mobile device communicates with a vehicle interface via either a short range wireless link, such as provided by a Bluetooth connection, or via a wired link. The vehicle interface device may include a processor, a GPS circuit, a long range wireless transceiver, such as a cellular telephony transceiver, as shown in TCU 101, but may transmit (e.g., via Bluetooth or similar) data received from vehicle 201 to a nearby mobile wireless device, which then either processes the data and generates alerts and reports, or processes the data into wireless data packets and sends to a remote computer via a wireless communications network 204 and other communications network 205.

At step 1010, the device that method 1000 is running on receives data corresponding to battery characteristic parameters (OCV, battery voltage during cranking event), battery environment parameters (engine temperature, ambient temperature) and vehicle usage parameters (length and duration of trips, number of trips or cranking events). At step 1015, the received data can be compared to corresponding parameter criteria. At step 1020, alerts can be generated and sent from the device running method 1000 to a user device, which could either be remote from, or could include an application running on the same device that method 1000 is running on (e.g., a TCU or a mobile wireless device).

At step 1025, method 1000 evaluates the received data more thoroughly than merely comparing to corresponding criteria, and forms a battery health value by processing the received data into a value based on weighting of each of the parameters. Reports based on the battery health value can be generated and sent at step 1030 so that a user stays apprised of his, or her, battery's health and predicted remaining life. It will be appreciated that other algorithms other than weighting of factors can also be used to determine a battery health value, or a useful remaining battery life data or value.

At step 1035, method 1000 may determine if a vehicle is equipped with a battery charging regulating controller (electrical device in line with charging wire from alternator to battery) that is controlled by a control signal from TCU 101, or wirelessly controlled from either a TCU or a mobile wireless device. Method 1000 can use received battery data, environmental data, and vehicle usage data to generate a customized charging profile that improves battery charging vis-á-vis a steady DC output from the alternator. If the vehicle is not so equipped, method 1000 ends at step 1040.

However, if the vehicle is so equipped, method 1000 can use the customized control signal profile, or charging profile, at step 1045 to alter the steady, constant-voltage output from a vehicle's alternator to possibly reduce the effects of sulfation, and counteract them before they reach stage where a cell's plates become irreparably altered due to sulfation. For example, the control signal can interrupt the current from the alternator, and even reverse its polarity, so that differing width pulses of forward or reverse polarity can be applied to the battery. Research has shown that often such customized charging current can reverse sulfation and charge a battery quicker than steady DC current can. Using data associated with a particular battery in a particular vehicle to customize a charging signal provides an advantage over using a predetermined charging current profile that may, or may not, provide optimal charging for a given battery and use. After generating a customized charging current profile for use in controlling the charging regulating device at step 1053, method 1000 ends at step 1040. It will be appreciated that step 1045 can comprise actually regulating the charging current according to the usage profile tailored to a battery coupled with the device running a program carrying out the instructions of method 1000, or step 1045 can comprise downloading a charging profile to a device coupled to the battery.

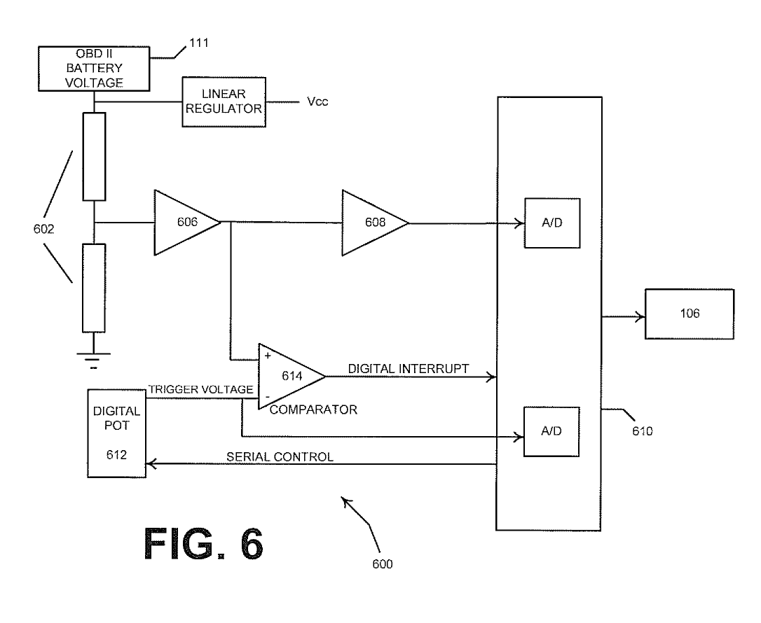

Turning now to FIG. 6, the figure illustrates a schematic diagram of an embodiment of a circuit 600 for detecting a battery cranking event and associated voltage levels. In the preferred embodiment, a voltage divider 602 splits the voltage between the positive battery voltage received through OBD port 111 and ground. Buffer 606 conditions the output of voltage divider 602 and its output is coupled with anti-alias low pass filter 608, which filters noise above preferably 100 kHz before microcontroller 610 processes the analog voltage level into a digital representation thereof. Microprocessor 610 forwards its output to main processor 106. Software running on main processor 106 can also set a threshold voltage value in digital potentiometer 612. Comparator 614 compares the buffered battery voltage from voltage divider 602 with the threshold, or trigger voltage value. If the battery voltage V0 from the voltage divider corresponds to a trigger voltage value that represents a threshold, or trigger, voltage, the output of comparator provides a signal to an interrupt input of microcontroller 610. Microcontroller 610 forwards an interrupt to main processor 106, which wakes up and begins storing and processing data sampled by the microcontroller.

Upon comparator 614 sending an interrupt signal to microcontroller 610, processor 106 wakes up in response thereto and begins sampling the voltage signal passed through filter 608. If processor 106 determines that the voltage has returned to a level above the trigger level within a few sample periods, then it may go back to a low power, or ‘sleep’ state. Processor may determine that the voltage that caused the interrupt signal was from a voltage spike 502, which may occur when a driver turns on a key but before a starter motor begins to turn an engine, if the after triggering, the battery voltage level from OBD port 111 has returned to a nominal battery level within the predetermined number of sample periods,

If, however, the voltage level from port 111 stays below the trigger level, controller 610 stores the time T0 at which comparator 614 sent the trigger, or interrupt, signal. Controller 610 continues to monitor the voltage values from OBD port 111 and voltage divider 602, and determines a time Tp when the battery voltage reaches a minimum voltage Vp. Controller 610 also determines a time Tn when the battery voltage reaches a predetermined voltage Vn. Vn may be arbitrarily chosen, i.e., the trigger voltage. The greater the period between Tp and Tn, generally the weaker the battery and closer it is to its end of life. Controller 610 also operates a counter of a predetermined period Tt (in reference to T0). If the counter counts to Tt before a battery's voltage reaches Vn following a cranking negative peak voltage Vp, method 1000 can send an alert indicating same and may use the fact in determine the battery's remaining useful life—generally the longer the time to reach Vn following Vp, or following T0, the less life a battery has remaining. Thus, the count period Tt, the healthy stable system voltage Vn, or both, can be configured so that if controller 610 counts period Tt before battery voltage at port 111 reaches Vn, method 1000 can send an alert and/or a message that the timer counted to Tt before battery voltage reached Vn, and that the battery may fail to crank the engine at an estimated time in the future.

The selecting of Vn and Tt may be based on theoretical calculations, or on empirical data collected from multiple vehicles. For example, Tn and Vn may be collected at a server computer from each of a plurality of vehicles in a fleet. After a battery fails to crank, a program running on the server may analyze the Tn and Vn values for a given vehicle for a period, for example three months, before the battery failed. As the server computer analyzes more and more data from the fleet of vehicles, the data may converge to indicate trends associated with degradation and corresponding battery failure. In addition to Tn and Vn, the server battery trend analysis program may also evaluate Vp and Tp, as the lower they are, respectively, the more degraded a battery tends to be.

Also, the trend analysis program can analyze driver behavior (i.e., number of short trips) and environmental data (i.e., battery temperature) in the three month (or other predetermined period) to identify conditions that typically occur before, and thus predict, battery failure. When monitored and processed data of a given battery indicates that some, or all, of the failure precursor conditions occur, method 1000 can generate and send alerts that the condition of the battery is degraded, to what extent the battery is degraded, and generate and send a report indicating the estimated time remaining of the battery's useful life.

While the methods and systems have been described in connection with preferred embodiments and specific examples, it is not intended that the scope be limited to the particular embodiments set forth, as the embodiments herein are intended in all respects to be illustrative rather than restrictive. Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification.

It will be apparent to those skilled in the art that various modifications and variations can be made without departing from the scope or spirit. Other embodiments will be apparent to those skilled in the art from consideration of the specification and practice disclosed herein. It is intended that the specification and examples be considered as exemplary only, with a true scope and spirit being indicated by the following claims.

What is claimed is:

1. A method for predicting and reporting battery health, comprising:
electronically receiving vehicle diagnostic data representing one, or more, of a plurality of electronically monitored vehicle parameters;
comparing the vehicle diagnostic data to predetermined diagnostic criteria corresponding to the vehicle parameters;
generating an alert message if the vehicle data does not meet the predetermined diagnostic criteria; and
initiating the sending of the alert message to a user device.

2. The method of claim 1 wherein the plurality of electronically monitored parameters include battery open circuit voltage after charging, a maximum voltage drop of the battery after a cranking event trigger, a time for OCV to return to a nominal voltage following cessation of alternator charging, a time until OCV exceeds a cranking threshold following the maximum voltage drop.

3. The method of claim 1 wherein the alert message is generated as at least one of an e-mail message, an SMS message, a voice call, a pager message, a video message.

4. The method of claim 1 further comprising:
electronically receiving vehicle environmental data corresponding to at least one of a plurality of electronically monitored conditions of the environment surrounding the vehicle;
comparing the environmental data to predetermined environmental criteria corresponding to the environmental parameters; and
generating an alert message if the vehicle data does not meet the predetermined environmental criteria.

5. The method of claim 1 wherein vehicle data over a predetermined period is compared to predetermined criteria and the alert indicates that projected battery life deviates from that of a predetermined nominal battery.

6. A method for predicting and reporting battery health, comprising:
electronically receiving vehicle usage data representing one, or more, of a plurality of electronically monitored vehicle usage parameters;
comparing the vehicle usage data to predetermined vehicle usage criteria corresponding to the vehicle usage parameters;
generating an alert message if the vehicle usage data does not meet the predetermined vehicle usage criteria; and
initiating the sending of the alert message to a user device.

7. The method of claim 6 wherein the plurality of electronically monitored vehicle usage parameters include the amount of cranking time during a period, the average ambient temperature during a predetermined period, average length of trips, frequency of trips, number of cranking events during a period.

8. The method of claim 6 wherein the alert message is generated as at least one of an e-mail message, an SMS message, a voice call, a pager message, a video message.

9. The method of claim 6 further comprising:
electronically receiving vehicle environmental data corresponding to at least one of a plurality of electronically monitored conditions of the environment surrounding the vehicle;
comparing the environmental data to predetermined environmental criteria corresponding to the vehicle environmental parameters; and
generating an alert message if the vehicle usage data does not meet the predetermined vehicle usage criteria and the environmental data does not meet the predetermined environmental criteria.

10. The method of claim 6 wherein vehicle usage data over a predetermined period is compared to predetermined vehicle usage criteria and the alert indicates that projected battery life deviates from that of a predetermined nominal battery.

11. The method of claim 6 further comprising electronically receiving vehicle diagnostic data representing one, or more, of a plurality of electronically monitored vehicle parameters, wherein the vehicle parameters include a maximum voltage drop of the battery after a cranking event trigger, a time for OCV to return to a nominal voltage following cessation of alternator charging, a time until OCV exceeds a cranking threshold following the maximum voltage drop;
generating an alert message if the vehicle usage data does not meet the predetermined vehicle usage criteria, if the environmental data does not meet the predetermined environmental criteria, and if the vehicle diagnostic data does not meet the predetermined vehicle diagnostic criteria; and
initiating the sending of the alert message to a user device.

12. A method for predicting and reporting battery health, comprising:
electronically receiving and processing vehicle usage data representing one, or more, of a plurality of electronically monitored vehicle usage parameters;
electronically receiving and processing vehicle diagnostic data representing one, or more, of a plurality of electronically monitored vehicle diagnostic parameters,
electronically receiving and processing vehicle environmental data corresponding to at least one of a plurality of electronically monitored conditions of the environment surrounding the vehicle; and
determining an remaining battery life value based on the processed vehicle usage data, the processed vehicle diagnostic data, and the processed environmental data.

13. The method of claim 12 wherein the battery life message is generated as at least one of an e-mail message, an SMS message, a voice call, a pager message, a video message.

14. The method of claim 12 further comprising generating an alert message if the processed vehicle usage data does not meet the predetermined vehicle usage criteria, if the processed environmental data does not meet the predetermined environmental criteria, and if the processed vehicle diagnostic data does not meet the predetermined vehicle diagnostic criteria; and
initiating the sending of the alert message to a user device.

15. The method of claim 12 further comprising using the received data to generate a customized charging current profile; and using the customized charging current profile to control charging current applied to the vehicle's battery.

16. The method of claim 12 further comprising receiving and processing vehicle voltage, environmental, and usage data for each of a plurality of vehicles, identifying conditions that exist during a predetermined period before failure of batteries corresponding to the plurality of vehicles, determining a trend of a time of the start of a condition occurring until a battery's failure, and reporting to a user associated with a particular vehicle that the its battery has a predicted remaining useful life based on the determined trend and the current condition of the particular vehicle's battery.

17. The method of claim 16 wherein the predetermined period before battery failure used in determining the trend of the start of a condition occurring until a battery's failure is three months.

18. The method of claim 12 further comprising initiating the sending of the remaining battery life value to a user device.

19. The method of claim 18 wherein the sending of the remaining battery life value is performed periodically.

20. The method of claim 12 further comprising sending an alert message to a user device when the remaining battery life value falls below a predetermined threshold.
